(19) United States
(12) Patent Application Publication
(10) Pub. No.: US 2021/0286973 A1
(43) Pub. Date: Sep. 16, 2021

(54) FACIAL RECOGNITION SYSTEM FOR A VEHICLE TECHNICAL FIELD

(71) Applicant: Ford Global Technologies, LLC, Dearborn, MI (US)

(72) Inventors: Ali Hassani, Ann Arbor, MI (US); Jake Schwartz, Dearborn, MI (US); John Robert Van Wiemeersch, Novi, MI (US)

(73) Assignee: Ford Global Technologies, LLC, Dearborn, MI (US)

(21) Appl. No.: 16/813,978

(22) Filed: Mar. 10, 2020

(51) Int. Cl. G06K 9/00; G06K 9/32; G06F 21/32; G06N 3/08; B60W 50/00

(52) U.S. Cl. CPC G06K 9/00228; G06K 9/00288; G06K 9/3233; B60W 2050/0089; G06F 21/32; G06N 3/084; B60W 50/0098; G06K 9/00832

(57) ABSTRACT

A vehicle is provided including one or more cameras and a controller coupled to the one or more cameras. The controller is operable to receive data from one or more devices, indicating a location of a user. Based on the data received from the one or more devices, the controller determines an estimated location of a face of the user. Further, the controller, in one or more images captured by the one or more cameras, searches a location of the face of the user based on the estimated location of the face. Thereby, the controller detects the location of the face of the use.

### TECHNICAL FIELD

The present disclosure relates to aspects of facial recognition for providing access to various operations in a vehicle.

### BACKGROUND

Vehicles may be equipped with biometric access systems that provide a user access to the vehicle and various operations thereof. In some vehicles, the user access may be provided by identifying the user using user's biometric data, such as user's fingerprint, retina scan, facial features, or the like.

### SUMMARY

The present disclosure relates to techniques to detect and recognize a face of a user.

An aspect of the present disclosure relates to a vehicle including one or more cameras and a controller coupled to the one or more cameras capturing one or more images. The controller is operable to receive data from one or more devices, indicating a location of a user. Based on the data received from the one or more devices, the controller determines an estimated location of a face of the user. Further, the controller, in the images captured by the one or more cameras, searches a location of the face of the user based on the estimated location of the face. Thereby, the controller detects the location of the face of the user.

According to another aspect of the present disclosure, a system includes one or more devices that are operable to provide data indicating a location of a user. The system further includes a vehicle having one or more cameras capturing one or more images and a controller coupled to the one or more cameras. The controller receives the data from the one more devices and determines an estimated location of a face of the user based on the received data. Subsequently, the controller searches a location of the face of the user in the images captured by the one or more cameras based on the estimated location. Finally, the controller detects the location of the face of the user.

Yet another aspect of the present disclosure relates to a method for detecting a location of a face of the user. The method includes a step of receiving, by a controller, data from one or more devices, indicating a location of the user. The one or more devices include a key fob, a connector to the key fob, a portable communication device, and/or a sensor on a vehicle. The method further includes a step of determining an estimated location of the face of the user by the controller based on the data received from the one or more communication devices. Further, the method includes a step of searching, by the controller in one or more images captured by one or more cameras, the location of the face of the user face based on the estimated location. Eventually, the method includes a step of detecting the location of the face of the user by the controller.

### BRIEF DESCRIPTION OF THE DRAWINGS

The above-mentioned aspects are further described herein with reference to the accompanying figures. It should be noted that the description and figures relate to exemplary aspects and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

FIG. 1 illustrates a system for detecting a face of a user, in accordance with the present disclosure;

FIG. 2 illustrates an interior of the vehicle having one or more cameras and devices positioned at different positions inside the vehicle, in accordance with the present disclosure;

FIG. 3 illustrates a schematic of a controller configured to detect the face of the user, in accordance with the present disclosure; and

FIG. 4 illustrates a method of detecting the face of the user, in accordance with the present disclosure.

### DETAILED DESCRIPTION

The present disclosure relates to a system and a method of detecting a location of a face of the user, identifying the user based on the detected face of the user, determining actions that the identified user is authorized to conduct on a vehicle, and authorizing the identified user to conduct the identified actions such as entering the vehicle, operating the vehicle, unlocking or locking a door of the vehicle, starting the vehicle, and/or driving the vehicle. The system and method of the present disclosure are designed to reduce latency in identifying and authorizing the user, along with reducing power consumption, computational time and resources.

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Unless the context indicates otherwise, throughout the specification and claims which follow, the word “comprise” and variations thereof, such as, “comprises” and “comprising” are to be construed in an open, inclusive sense that is as “including, but not limited to.” Further, the terms “first,” “second,” and similar indicators of the sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

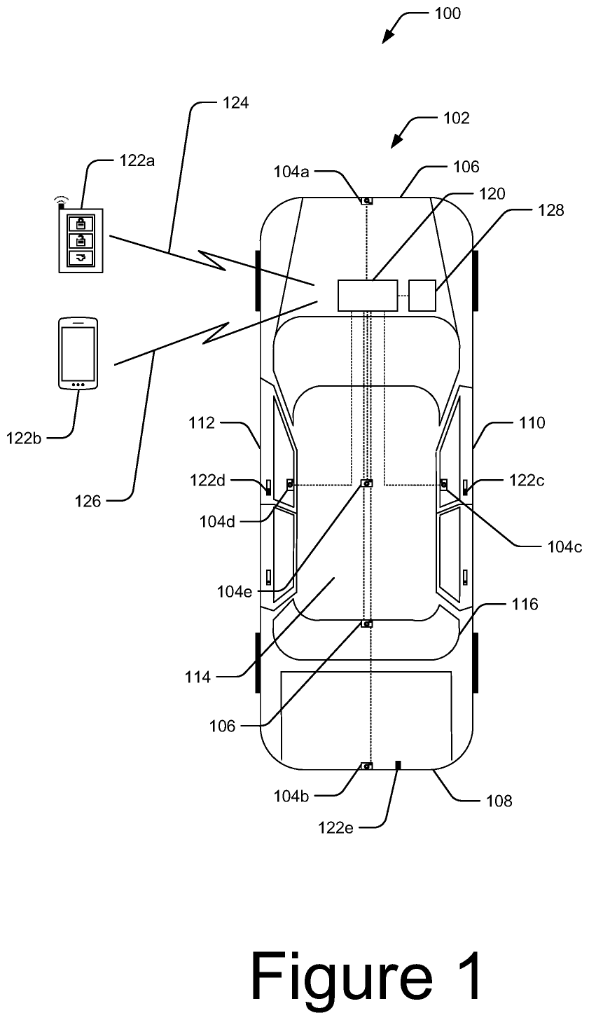

FIG. 1 illustrates a system 100 configured to detect a face of a user (not shown), in accordance with the present disclosure. The system 100 includes a vehicle 102 having one or more cameras 104a, 104b, 104c, 104d, 104e, 104f, 104g (collectively referred to as one or more cameras 104 hereinafter) installed on the vehicle 102. The one or more cameras 104 may be configured to capture one or more real-time images of the face of the user such that the captured images may be used to detect a location of the face of the user. In at least one example, the cameras 104 can capture images of the environment around the vehicle 102. For example, the cameras 104 may capture images of the garage, parking lot, passersby, and/or weather around the vehicle 102. The one or more cameras 104 may be installed on, in, and/or around the vehicle 102. For example, the cameras 104a and 104b are installed on a front end 106 and a rear end 108 of the vehicle 102, respectively, while the cameras 104d and 104c are installed proximate to a driver door 112 and a front passenger door 110, respectively. The camera 104e may be a 360-degree camera configured to scan the surroundings of the vehicle 102 in 360 degrees. In at least one example, the camera 104e may be installed on a roof 114 of the vehicle 102. The camera 104e may be mounted at any location of the vehicle 102 suitable to capture 360 degree views of the surroundings of the vehicle 102. In some examples, more than one camera 104 may be utilized to provide a compiled 360 degree view of the surroundings of the vehicle 102.

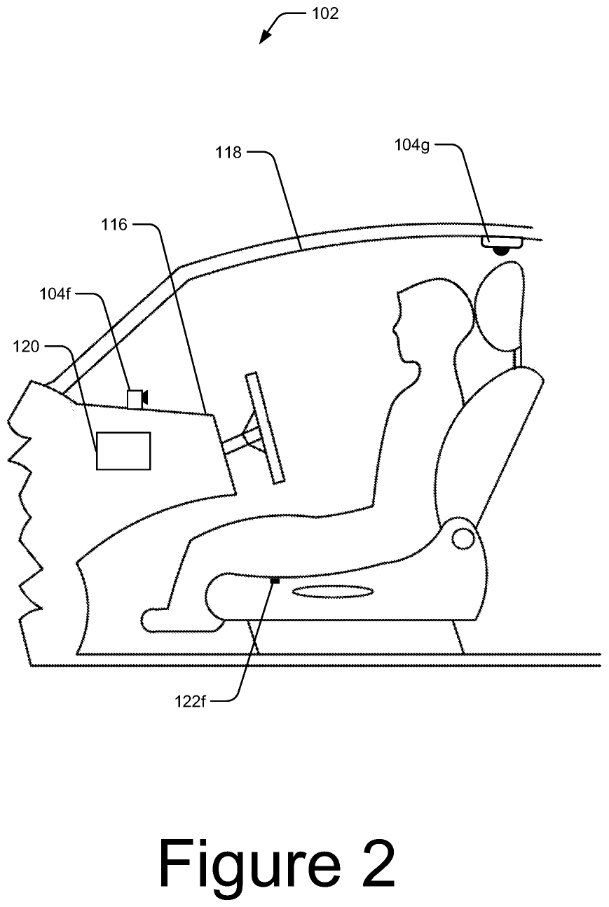

As shown in FIG. 2, one or more cameras 104 may be positioned or installed in the interior of the vehicle 102. For example, the camera 104f is mounted on a dashboard 116 of the vehicle 102, while the camera 104g is mounted on an inner ceiling 118 of the vehicle 102. In at least one example, the one or more cameras 104 can be high-resolution cameras that are configured to capture high definition (HD) or full-high definition (Full-HD) images. Such high-definition images may be used by the system 100 to detect and/or track the location of the face of the user with more accuracy. In some examples, the cameras 104 can capture video. In some examples, the one or more cameras 104 may capture video and provide a real-time feed to detect and/or track the location of the face of the user.

Referring to FIG. 1, the vehicle 102 further includes a controller 120 communicatively coupled with the one or more cameras 104. The controller 120 determines an estimated location of the face of the user based on received data indicating a location of the user. The controller 120 can then, using the cameras 104, search the determined one or more estimated locations in and/or around the vehicle 102 and detect the location of the face of the user. The controller 120 can further determine an identity of the user based on the detected face of the user, determine actions that the user is authorized to conduct on the vehicle 102 based on the identity of the user, and/or provide authorization for the user to conduct the actions. By first determining an estimated location of the face of the user, the controller 120 can save search time, processing time, and/or processing power to detect the face of the user.

In at least one example, one or any of the cameras 104 may be configured to rotate, pivot, and/or translate. For example, the camera 104 may be coupled to a motor which can move the camera 104. In some examples, the controller 120 can control the motor to move the camera 104 to detect and/or track the location of the face of the user.

A vehicle control system 128, such as an engine control unit (ECU), can be coupled with the controller 120 and can enable the user to perform the actions on the vehicle 102. The actions, in at least one example, may include, but is not limited to, entering the vehicle 102, operating the vehicle 102, locking/unlocking door of the vehicle 102 such as the driver door 112, the front passenger door 110, and/or the trunk; starting the vehicle 102; and/or driving the vehicle 102. In some examples, the vehicle control system 128 may alternately be integrated into the controller 120. The data indicating the location of the user can be received by the controller 120 from one or more devices 122a, 122b, 122c, 122d, 122e, 122f, collectively referred to as one or more devices 122 herein, of the system 100. The one or more devices 122 are communicatively coupled with the controller 120, and provides the data indicating the location of the user. In at least one example, the one or more devices 122 may be located outside and/or be separate from the vehicle 102. The data from the one or more devices 122 can include one or more of, but not limited to, time, location, user interaction with the vehicle 102, and/or proximity of the user to the vehicle 102. The time may include time at which an authorization to perform at least one of the actions on the vehicle 102 is received by the system 100 and/or time at which the location of the user is detected. The location may include the location of the user.

In at least one example, the one or more devices 122 may include a key fob 122a that may provide data corresponding to the proximity of the user with respect to the vehicle 102 over a short-range communication link 124. In at least one example, the one or more devices 122 can include a connector to the key fob 122a. In some examples, the one or more devices 122 may include a portable communication device 122b, such as a mobile device or the like, that may provide geo-coordinate data of the portable communication device 122b over a long-range communication link 126, thereby indicating the proximity of the user with respect to the vehicle 102. The controller 120, based on the received geo-coordinate data, may estimate the direction from which the user is approaching the vehicle 102.

In some examples, the one or more devices 122 may include a sensor installed on the vehicle 102. For example, the one or more devices 122 may include the driver door access sensor 122c mounted on the driver door 112 that provides data indicating the location of the user when the user comes in proximity or vicinity of the driver door handle 110. In another example, the one or more devices 122 may include the passenger door access sensor 122d mounted on a passenger door such as the front passenger door 110 that provides the data of the location of the user when the user is proximate to the front passenger door 110. In yet another example, the one or more devices 122 may include the trunk sensor 122e mounted at the rear end 108 of the vehicle 102 and provide the data regarding the location of the user when the user is proximate to the rear end 108 or the trunk of the vehicle 102. In some examples, the sensors can be installed to sense when the user is proximate to and/or interacting with the vehicle 102 such as touching any door or portion of the vehicle 102.

Similarly, one or more other devices 122 may be installed in the interior of the vehicle 102 to provide data regarding the location of the user when the user is inside the vehicle 102. One such interior device of the one or more devices 122 may include the occupant sensor 122f that provides data when the user has occupied a seat inside the vehicle 102, as shown in FIG. 2.

Any single, combination, or all of the one or more devices 122 may be utilized in the system 100 as desired to provide data on the location of the user. The devices 122 providing data on the location of the user further enhances the ability of the controller 120 to accurately and efficiently estimate and detect the location of the user.

The controller 120 relies on the one or more devices 122 to estimate the location of the user that initiates the one or more cameras 104 to locate the face of the user. Such a technique does away with the need for initiating all of the one or more cameras 104 simultaneously, thereby reducing the power consumption. Additionally, since the controller 120 is not required to process images or video feed from all of the one or more cameras 104, the time required to search and detect the location of the face of the user reduces, which further reduces the latency of the system 100. Moreover, the controller 120 processes a portion of the image instead of the complete image, thereby also reducing the computational time and resources.

In at least one example, the controller 120 can learn the behavior of the user to improve the identification of a region of interest while detecting the face and/or determining the identity of the user, for example, facial detection and recognition. Such learning keeps on improving the accuracy of the process of detecting the face of the user over a period of time, thereby improving the overall efficiency and performance of the system 100.

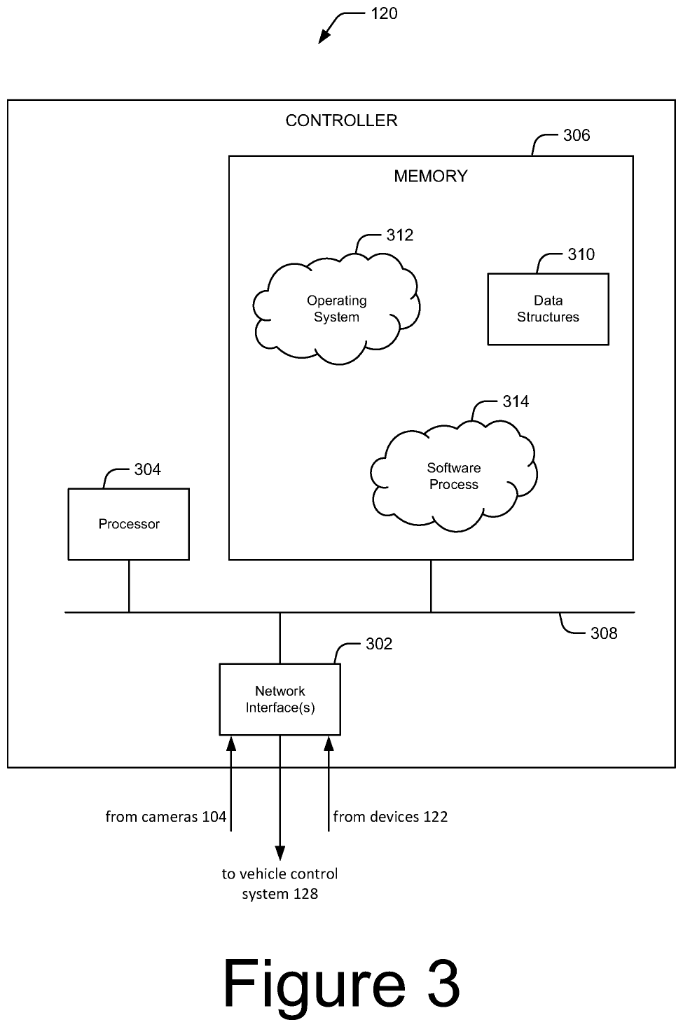

FIG. 3 illustrates a schematic diagram of the controller 120, in accordance with the present disclosure. As illustrated in FIG. 1, the controller 120 can be operable to communicate with the cameras 104 and/or the devices 122 to detect the location of the face of the user, determine the identity of the user based on the face of the user, and/or provide authorization for the user to conduct the actions in the vehicle 102. Those skilled in the art would understand that while the controller 120 communicates with one or more of the above-discussed components, it should be noted that the controller 120 may also communicate with other remote devices/systems.

As shown, the controller 120 includes hardware and software components such as network interfaces 302, at least one processor 304, and a memory 306 interconnected by a system bus 308. In one example, the network interface(s) 302 may include mechanical, electrical, and signaling circuitry for communicating data over communication links (not shown), which may include wired or wireless communication links. Network interfaces 302 are configured to transmit and/or receive data using a variety of different communication protocols, as will be understood by those skilled in the art.

The processor 304 represents a digital signal processor (e.g., a microprocessor, a microcontroller, or a fixed-logic processor, etc.) configured to execute instructions or logic to perform tasks. The processor 304 may include a general-purpose processor, special-purpose processor (where software instructions are incorporated into the processor), a state machine, application-specific integrated circuit (ASIC), a programmable gate array (PGA) including a field PGA, an individual component, a distributed group of processors, and the like. The processor 304 typically operates in conjunction with shared or dedicated hardware, including but not limited to, hardware capable of executing software and hardware. For example, the processor 304 may include elements or logic adapted to conduct software programs and manipulate the data structures 310, which may reside in the memory 306.

The memory 306 comprises a plurality of storage locations that are addressable by the processor 304 for storing the software programs and the data structures 310 associated with the aspects described herein. An operating system 312, portions of which may be typically resident in the memory 306 and executed by the processor 304, functionally organizes the device by, inter alia, invoking actions in support of the software processes and/or services 314 executing on Controller 120. These software processes and/or services 314 may perform processing of data and communication with the controller 120, as described herein. Note that while the software process/service 314 is shown in the centralized memory 306, some examples provide for these processes/services to be operated in a distributed computing network.

According to an example, the memory 306 may store spatial data pertaining to the cameras 104. The spatial data may include position and elevation of each camera 104 mounted inside and outside the vehicle 102. Such information may be required for detecting the location of the user's face. The memory 306 may also hold historical information, such as frequency of use by users, environment of the vehicle, neighboring users, height of users, previous interactions, and/or time and location when the user's face was previously identified to provide vehicle access, and the details of the one or more cameras 104 that were used to detect the face of the user. A manner in which such information is used to detect the location of the face of the user is explained in subsequent paragraphs. The memory 306 may also store information regarding the identity of multiple users and the actions that each user is authorized to conduct upon successful face detection by the system 100.

It will be apparent to those skilled in the art that other processor and memory types, including various computer-readable media, may be used to store and conduct program instructions pertaining to face detection/recognition techniques described herein. Also, while the description illustrates various processes, it may be contemplated that various processes may be embodied as modules having portions of the process/service 314 encoded thereon. In this fashion, the program modules may be encoded in one or more tangible computer-readable storage media for execution, such as with fixed logic or programmable logic (e.g., software/computer instructions executed by a processor, and any processor may be a programmable processor, programmable digital logic such as field-programmable gate arrays or an ASIC that comprises fixed digital logic). In general, any process logic may be embodied in the processor 304 or computer-readable medium encoded with instructions for execution by the processor 304 that, when executed by the processor, are operable to cause the processor to perform the functions described herein. The controller 120 may also include a location unit (not shown) that may provide location data, such geo-coordinates of the vehicle 102.

In operation, based on the data received from the one or more devices 122 indicating the location of the user, the controller 120 determines the estimated location of the face of the user. In at least one example, the controller 120 may use historical information stored in the memory 306 to identify the estimated location of the face of the user. The historical information may include, but is not limited to, frequency of use of the vehicle 102 by the user, environment of the vehicle 102, neighboring users, height of the user and/or the neighboring users, previous interactions, and/or time.

The controller 120 then, based on the estimated location of the face of the user, selects the one or more cameras 104 such that the controller 120 may use data received from the selected one or more cameras 104 to search and determine the location of the face of the user. The data from the selected one or more cameras may include the images or the video feed captured in the real-time of the estimated location of the face of the user. In at least one example, the controller 120, upon receipt of the data from the portable communication device 122b, estimates that the user is approaching the vehicle 102 from the front and determines the cameras 120 that can capture that estimated location. For example, the controller 120 can utilize the camera 104a mounted at the front end 106 of the vehicle 102 to capture the image and detect the location of the face of the user. In some examples, the controller 120 may also use the camera 104e mounted on the roof 114 of the vehicle 102 to capture the image and detect the location of the face of the user. Specifically, the controller 120 may detect the location of the face of the user in frames of the images and/or the video feed captured by the selected one or more cameras 104 and received by the controller 120. For example, the controller 120 may identify a sub-frame within the frames of the images and/or video feed such that the controller 120 may apply one or more face detection techniques on the identified sub-frame to detect the location of the face of the user.

In at least one example, the controller 120 may receive data from the portable communication device 122b that the user is approaching the vehicle 102 from the front and is about 2 meters from the vehicle 102. The controller 120 may identify a top center portion of the image and/or video feed captured by the selected camera 104a mounted at the front end 106 as the sub-frame in which the face of the user is likely to be located. The controller 120 uses the one or more face detection techniques to detect the face of the user.

Further, the one or more face detection techniques may include Viola-Jones object detection technique, Scale-invariant feature transform (SIFT) technique, Histogram of oriented gradients (HOG), Regional-Convolutional Neural Network (R-CNN) technique, Single Shot MultiBox Detector (SSD) technique, You Only Look Once (YOLO) technique or Single-Shot Refinement Neural Network for Object Detection (RefineDet) technique, and the like. Since the controller 120 is applying the face detection technique on the identified sub-frame instead of the entire image, the detection of the face of the user is quick, accurate and requires less computational resources. When the controller 120 does not detect the face of the user in the identified sub-frame, the controller 120 may identify the next possible sub-frame using the data from another device of the one or more devices 122 or using another image of the captured images from the same or another camera of the one or more cameras 104. In some examples, the controller 120 may identify the next sub-frame within the same image using the historical information which can include frequency of use by users, environment of the vehicle, neighboring users, height of users, previous interactions, and/or time.

In at least one example, after detecting the location of the face of the user, the controller 120 can apply facial recognition techniques to determine the identity of the user. In some examples, the controller 120 may compare data pertaining to the identity of the user stored in the memory 306 with the face detected in the sub-frame. When the sub-frame includes faces of multiple users, the controller 120 may identify the neighboring user and determine the level of authorization of the user and the neighboring user. For example, the controller 120 may determine that the identified user is a child. The controller 120 may determine that the child is authorized to enter the vehicle 102 and is not authorized to the start the vehicle 102. Accordingly, the controller 120 may send instructions to the vehicle control system 128 to unlock the door when the child is proximate to, is in contact with, and/or operates the door handle but prevents the child to start the vehicle 102. In another example, the controller 120 determines that the user is within a predetermined distance from the rear end 108 of the vehicle 102 and determines that the identified user is authorized to access the trunk of the vehicle 102. Accordingly, the controller 120 may send instructions to the vehicle control system 128 to authorize the user to open the trunk of the vehicle 102.

In at least one example, the controller 120 may also be configured to track the face of the user. The controller 120 may identify a centroid of the detected face. To accomplish the identification of the centroid, the controller 120 may process the sub-frame with respect to a cartesian plane and compute the centroid using known mathematical models that are employed to determine the centroid of an image. Further, in some examples, the centroid may be cartesian coordinates. Thereafter, the controller 120 may create a region of interest around the centroid. The region of interest is used to track the face of the user in cases where the user changes position with respect to the one or more cameras 104. For example, the tracking is required to determine the type of authorization to be provided to the user based on the user's position with respect to the vehicle 102. Moreover, tracking the face of the user may be to reduce or eliminate a need to re-estimate the sub-frame to detect the face of the user, thereby alleviating the need to invest further computational time and resources to re-estimate the sub-frame.

In at least one example, the region of interest is a dynamic region of interest, such that the region of interest may be adjusted according to the face of the user. Further, the dynamic region of interest may be sized based on the size of the detected face. In one example, an area of the dynamic region of interest may be 25% greater than an area of the detected face. In some examples, the region of interest may be shaped to capture the head and/or a predetermined area around the head. For example, the region of interest may be substantially an oval, a circle, a rectangle, or any other suitable shape. Such shaping and/or sizing may allow the controller 120 to conveniently track the face. Moreover, the controller 120 may check if the centroid of the detected face changes when the user changes position with respect to the one or more cameras 104, and accordingly, the controller 120 detects the motion and adjusts the dynamic region of interest. For example, if the user moves towards the left of the one or more cameras 104, the captured image shows the user's face slightly left as compared to the position of the centroid in the previously captured image. Accordingly, the controller 120 may determine that the centroid has shifted towards the left. As a result, the controller 120 shifts the dynamic region of interest to a degree such that the face remains within the dynamic region of interest.

According to at least one example, the dynamic region of interest may also be used to quickly predict the sub-frame in another captured image when the user enters the field of vision of another camera of the one or more cameras 104. For example, when the user previously identified using the images from the camera 122c mounted on the driver door 112 moves towards the rear end 108 of the vehicle 102, the controller 120 determines that the face of the user is moving towards the left of the sub-frame. Accordingly, the controller 120 tracks the face of the user using the dynamic region of interest. Moreover, the controller 120 also determines when the face of the user is no longer in the image captured by the camera 104d, and accordingly, the controller 120 determines that the face of the user may appear in the images captured by the camera 104b mounted on the rear end 108 of the vehicle 102. Further, the controller 120 may estimate the sub-frame to be a left middle portion of the image captured from the camera 104b mounted at the rear end 106 of the vehicle 102.

The controller 120 of the present subject matter may be capable of learning behavior of the user to improve the face detection, recognition, and/or tracking, thereby further reducing the computational time and/or resource. According to the present subject matter, the controller 120 may apply semi-supervised learning technique, such as reinforcement based machine learning to determine the estimated location of the face of the user. In at least one example, the controller 120 may use a reward function to bias the estimated location of the face. Further, the reward function may be implemented based on various factors, such as success when the face is detected, an alternative path by the user, and/or recognition of a different user. For example, the controller 120 may track instances when the detection of the sub-frame is correct and when the detection of the sub-frame is incorrect. In addition, the controller 120 may also record instances of the corrective measures and the time the corrective measures are taken to accurately detect the face. The controller 120 may also record the detection of the sub-frame, time and place of detection, and other such details as the historical information on which the controller 120 may apply known aforementioned machine learning techniques to determine the estimated location of the face of the user.

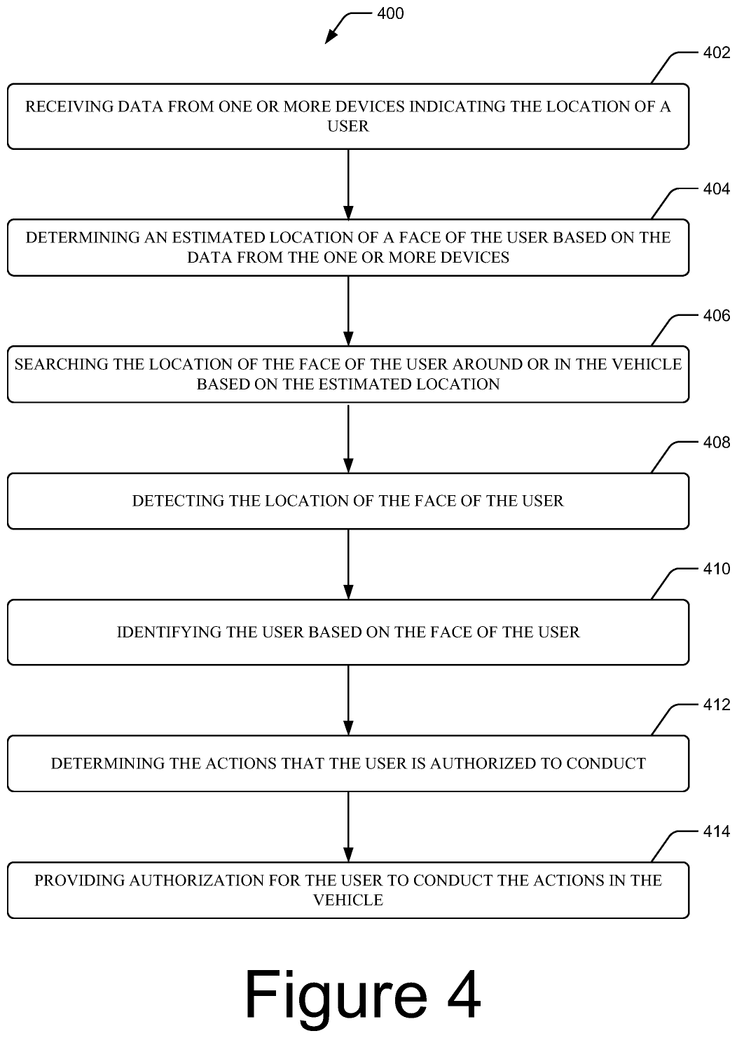

Referring to FIG. 4, a flowchart is presented in accordance with an example embodiment. The method 400 is provided by way of example, as there are a variety of ways to carry out the method. The method 400 described below can be carried out using the configurations illustrated in FIG. 1-3, for example, and various elements of these figures are referenced in explaining example method 400. Each block shown in FIG. 4 represents one or more processes, methods or subroutines, carried out in the example method 400. Furthermore, the illustrated order of blocks is illustrative only and the order of the blocks can change according to the present disclosure. Additional blocks may be added or fewer blocks may be utilized, without departing from this disclosure. The example method 400 can begin at block 402.

At block 402, the controller receives the data from the one or more devices, indicative of the location of the user. The devices can include a key fob, a connector to the key fob, a portable communication device, and/or a sensor on the vehicle. The data from the devices can include time, location, user interaction, and/or proximity of user.

At block 404, the controller determines the estimated location of the face of the user based on the data received from the one or more devices. For example, the controller may determine the location of the user with respect to the vehicle in order to determine the estimated location of the face of the user. In some examples, the determination of the estimated location of the face of the user can be further based on historical information. The historical information can include one or more of: frequency of use by users, environment of the vehicle, neighboring users, height of users, previous interactions, and/or time.

Once the controller determines the estimated location of the face of the user, the controller, at block 406, searches for the location of the user either around or inside the vehicle using the images captured by one or more cameras. In at least one example, the controller receives and processes the images and/or video feed captured by the one or more cameras.

At block 408, the controller detects the location of the face of the user. For example, the controller may identify the sub-frame in which the face of the user is likely to appear and accordingly detects the location of the face of the user. At block 410, the controller identifies the user based on the face of the user using the face recognition technique as explained above. Once identified, the controller, at block 412, determines the actions that the identified user is authorized to conduct. At block 414, the controller provides the authorization to the user to conduct the identified actions. As discussed in previous examples, the actions may include one or more of: entering the vehicle, operating the vehicle, unlocking or locking a door of the vehicle, such as the driver door and the passenger door, starting the vehicle, and/or driving the vehicle.

In some examples, a dynamic region of interest can be created around the face of the user. The face of the user can then be tracked by searching and adjusting the dynamic region of interest.

In at least one example, the determination of the estimated location of the face, detection of the face, and/or tracking of the face can be completed using semi-supervised learning such that the controller uses a reward function to bias the estimated location based on: success when the face is detected, an alternative path by the user, and/or recognition of a different user.

Although the disclosure has been described with reference to specific embodiments, this description is not meant to be construed in a limiting sense. Various modifications of the disclosed embodiments, as well as alternate embodiments of the disclosure, will become apparent to persons skilled in the art upon reference to the description of the disclosure. It is therefore contemplated that such modifications may be made without departing from the spirit or scope of the present disclosure as defined

1. A vehicle configured to detect and/or track a face of a user, the vehicle comprising:
one or more cameras capturing one or more images; and
a controller coupled with the one or more cameras, the controller operable to:
receive data from one or more devices indicating a location of a user,
determine, based on the data from the one or more devices, an estimated location of a face of the user,
search, in the images captured by the one or more cameras, a location of the face of the user based on the estimated location, and
detect the location of the face of the user.

2. The vehicle of claim 1, wherein the controller is further operable to:
determine an identity of the user based on the face of the user,
determine actions that the user is authorized to conduct, the actions including one or more of: entering the vehicle, operating the vehicle, unlocking or locking a door of the vehicle, starting the vehicle, and/or driving the vehicle, and
provide authorization for the user to conduct the actions in the vehicle.

3. The vehicle of claim 1, wherein the data from the one or more devices includes one or more of: time, location, user interaction, and/or proximity of the user.

4. The vehicle of claim 3, wherein the one or more devices include a key fob, a connector to the key fob, a portable communication device, and/or a sensor on the vehicle.

5. The vehicle of claim 1, wherein the determination of the estimated location of the face of the user is further based on historical information, the historical information including one or more of: frequency of use by users, environment of the vehicle, neighboring users, height of users, previous interactions, and/or time.

6. The vehicle of claim 1, wherein the controller is further operable to:
create a dynamic region of interest around the face of the user, and
track the face of the user by searching and adjusting the dynamic region of interest.

7. The vehicle of claim 1, wherein the determination of the estimated location of the face includes semi-supervised learning such that the controller uses a reward function to bias the estimated location based on: success when the face is detected, an alternative path by the user, and/or recognition of a different user.

8. A system comprising:
one or more devices operable to provide data indicating a location of a user; and
a vehicle including one or more cameras capturing one or more images and a controller coupled with the one or more cameras, the controller operable to:
receive the data from the one or more devices,
determine, based on the data from the one or more devices, an estimated location of a face of the user,
search, in the images captured by the one or more cameras, a location of the face of the user based on the estimated location,
detect the location of the face of the user.

9. The system of claim 8, wherein the controller is further operable to:
determine an identity of the user based on the face of the user,
determine actions that the user is authorized to conduct, the actions including one or more of: entering the vehicle, operating the vehicle, unlocking or locking a door of the vehicle, starting the vehicle, and/or driving the vehicle, and
provide authorization for the user to conduct the actions in the vehicle.

10. The system of claim 8, wherein the data from the one or more devices includes one or more of: time, location, user interaction, and/or proximity of user.

11. The system of claim 10, wherein the one or more devices include a key fob, a connector to the key fob, a portable communication device, and/or a sensor on the vehicle.

12. The system of claim 8, wherein the determination of the estimated location of the face of the user is further based on historical information, the historical information including one or more of: frequency of use by users, environment of the vehicle, neighboring users, height of users, previous interactions, and/or time.

13. The system of claim 8, wherein the controller is further operable to:
create a dynamic region of interest around the face of the user, and
track the face of the user by searching and adjusting the dynamic region of interest.

14. The system of claim 8, wherein the determination of the estimated location of the face includes semi-supervised learning such that the controller uses a reward function to bias the estimated location based on: success when the face is detected, an alternative path by the user, and/or recognition of a different user.

15. A method comprising:
receiving, by a controller, data from one or more devices indicating a location of a user, the one or more devices including a key fob, a connector to the key fob, a portable communication device, and/or a sensor on a vehicle;
determining, by the controller based on the data from the one or more devices, an estimated location of a face of the user;
searching, by the controller in one or more images captured by one or more cameras, a location of the face of the user around or in the vehicle based on the estimated location; and
detecting, by the controller, the location of the face of the user.

16. The method of claim 15, further comprising:
determining, by the controller, an identity of the user based on the face of the user;
determining actions that the user is authorized to conduct, the actions including one or more of: entering the vehicle, operating the vehicle, unlocking or locking a door of the vehicle, starting the vehicle, and/or driving the vehicle; and
providing authorization for the user to conduct the actions in the vehicle.

17. The method of claim 15, wherein the data from the one or more devices includes one or more of: time, location, user interaction, and/or proximity of user.

18. The method of claim 15, wherein the determination of the estimated location of the face of the user is further based on historical information, the historical information including one or more of: frequency of use by users, environment of the vehicle, neighboring users, height of users, previous interactions, and/or time.

19. The method of claim 15, further comprising:
create a dynamic region of interest around the face of the user, and
track the face of the user by searching and adjusting the dynamic region of interest.

20. The method of claim 15, wherein the determination of the estimated location of the face includes semi-supervised learning such that the controller uses a reward function to bias the estimated location based on: success when the face is detected, an alternative path by the user, and/or recognition of a different user.
